(19) United States
(12) Patent Application Publication
(10) Pub. No.: US 2003/0223318 A1
(43) Pub. Date: Dec. 4, 2003

(54) Digital contents playback apparatus

(75) Inventor: Takehiro Onomatsu, Osaka (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/449,493

(22) Filed: Jun. 2, 2003

(30) Foreign Application Priority Data
Jun. 3, 2002 (JP) 2002-161961

(51) Int. Cl. G11B 7/085

(52) U.S. Cl. 369/30.2

(57) ABSTRACT

A digital contents playback apparatus is provided for, upon switching on the power, retrieving reproducible data of the contents to be played back by its DVD playback module or a hard disk record/playback module, reading from a memory the available broadcast channels to be intercepted by its tuner, and producing a list of all the digital contents which can selectively be viewed. The list of the digital contents is itemized with the title of the content, the name or type of the recording medium, the date of recording, and so on so that it functions as an interface for selecting actions, thus contributing to the ease of selection of the content.

### BACKGROUND OF THE INVENTION

The present invention relates to a digital contents playback apparatus for playing back a variety of digital contents stored on different type recording mediums.

Some compatible digital contents playback apparatuses have been developed, each including two or more different digital recording media playback modules, which may be a combination of an optical disk playback module and a hard disk record/playback module, for playing back a variety of digital contents stored on different recording mediums (for example, optical disks or hard disks). It is common in such a digital contents playback apparatus that the shift of action from an optical disk to a hard disk is initiated by an action mode switching command from an entry device such as a remote commander.

Similarly, a data processing apparatus such as a personal computer is disclosed which is arranged responsive to a command, which is produced by a user directing the retrieval of different types of data, for selectively processing a desired content of the data while displaying the contents of all the different types of the data to be visually identified (for example, in Japanese Laid-open Patent Publication No. HEI 8-6962). Another data processing apparatus is disclosed where two or more text files are displayed in a list for identification of their contents (for example, in Japanese Laid-open Patent Publication No. 2001-22734).

While the contents of digital data to be played back is critical to the user, their storage mediums are not important. As described above, however, the conventional digital contents playback apparatus is arranged to carry out the shift of action from an recording medium to another one in response to a command from the remote commander. This requires a user to operate the remote commander while identifying the recording medium, e.g., a DVD or a hard disk, on which the data of desired contents is recorded.

Also, the above data processing apparatuses disclosed in HEI 8-6962 and 2001-22734 require the user to view lists of the different types of the data on the storage mediums through carrying out a troublesome action of, e.g., entering a corresponding command after the start up of a dedicated OS (operating system).

### SUMMARY OF THE INVENTION

The present invention has been developed for eliminating of the foregoing drawbacks and its object is to provide a digital contents playback apparatus equipped with a user-friendly interface for playing back any desired content without requesting the user for any troublesome action and identification of the type of the recording medium.

For achievement of the object, an aspect of the present invention provides a digital contents playback apparatus having two or more playback means for playing back different types of recording mediums on which digital contents of data are stored, comprising: an automatic contents retrieving means for automatically retrieving reproducible data of the digital contents from each recording medium upon switching on a power of the digital contents playback apparatus; and a contents data displaying means for producing a list of the contents from the data retrieved by the automatic contents retrieving means and displaying the list on an externally connected display device, wherein the contents data displaying means is arranged to display at once a list of the available digital contents retrieved over all the applicable recording mediums by the automatic contents retrieving means upon switching on the power of the apparatus.

The list of the digital contents displayed automatically upon switching on the power of the digital contents playback apparatus functions as the interface for selecting actions, thus contributing to the ease of selection of the contents by the user. The list of the digital contents represents at a glance all the reproducible data of the contents stored on the optical disk and the hard disk. More particularly, as the digital contents in the list are identified with its title, the name of its recording medium, the date of recording, and any other applicable data used for selection, they can selectively be viewed without difficulty.

Preferably, the digital contents playback apparatus further comprises an entry means for allowing a user to enter a variety of commands; and a content selecting means for selecting, in response to a command from the entry means, a desired content from the list of the contents produced and displayed on the display device by the contents data displaying means.

Preferably, in the digital contents playback apparatus, the playback means are an optical disk playback means for playing back the digital contents stored on an optical disk and a hard disk record/playback means for recording desired contents of data on a hard disk and playing back any selected one of the contents, and the automatic contents retrieving means includes an automatic optical disk retrieving means for automatically retrieving from the optical disk reproducible data of the contents to be played back by the optical disk playback means upon switching on a power of the apparatus and an automatic hard disk retrieving means for automatically retrieving from the hard disk reproducible data of the contents to be played back by the hard disk record/playback means upon switching on the power of the apparatus.

Preferably, the digital contents playback apparatus further comprises a signal receiving means for receiving digital broadcast signals from each local station; and a channel storage means in which data of broadcast channels which can be received by the signal receiving means are stored, wherein the contents data displaying means is arranged to produce a list of the digital contents from the available data retrieved over all the applicable recording mediums by the automatic contents retrieving means and the data of the broadcast channels stored in the channel storage means.

Preferably, in the digital contents playback apparatus, the contents data displaying means is arranged to modify the layout of the contents of digital data and broadcast channels in the list to a desired form determined by a user and display a modification of the list of the digital contents and the broadcast channels.

### BRIEF DESCRIPTION OF THE DRAWINGS

FIG. 1 is a block diagram of an electrical arrangement of a digital contents playback apparatus showing one embodiment of the present invention;

FIG. 2 is a view of a display screen of a list of the contents displayed on the apparatus; and

FIG. 3 is a flowchart showing the action of a controller in the apparatus for playing back the content of data as starting with the energization.

### DETAILED DESCRIPTION OF THE PREFERRED EMBODIMENTS

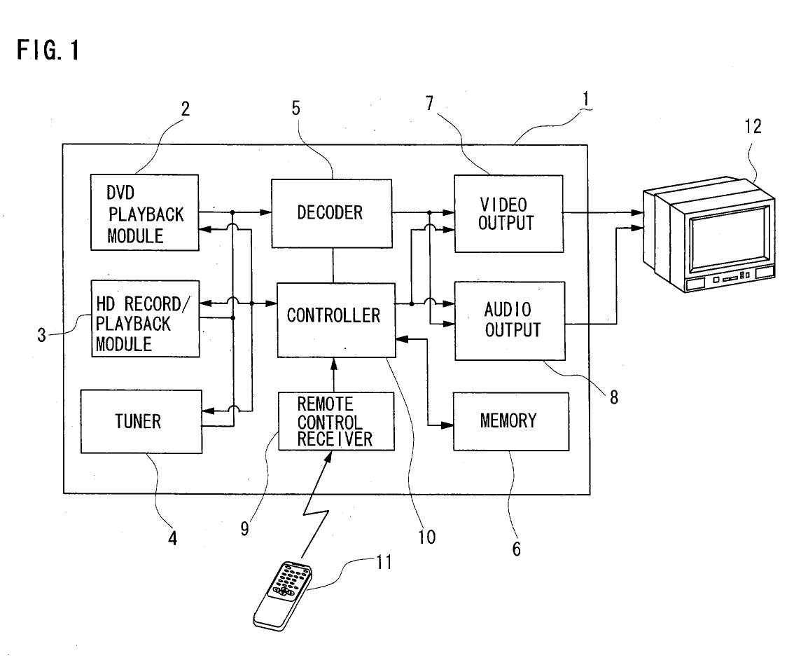

A digital contents playback apparatus of one embodiment according to the present invention will be described referring to the relevant drawings. FIG. 1 is a schematic view of the digital contents playback apparatus. The digital contents playback apparatus 1 includes two or more different type digital recording medium playback modules for playing back a desired content of the data stored on the different recording mediums and feeding an externally linked monitor 12 with its video and audio signals. More specifically, the digital contents playback apparatus 1 comprises a DVD (digital versatile disk) playback module 2 (an optical disk playback means), a hard disk record/playback module 3 (a hard disk record/playback means), a tuner 4 (a receiving means), a decoder 5, a memory 6 (a channel storage means), a video output 7, an audio output 8, a remote control receiver 9, a controller 10 (including an automatic optical disk retrieving means, an automatic hard disk retrieving means, a contents displaying means, a contents selecting means, and an automatic contents retrieving means), and a remote commander 11 (an entry means).

The DVD playback module 2 is designed for reading out a signal of a digital content from an optical disk. The hard disk record/playback module 3 is designed for recording and reading out a signal of a desired digital content on a hard disk. The signal of the digital content to be stored on a hard disk may incorporate video files conforming to MPEG2 standards or audio files conforming to MP3 standards. The tuner 4 is designed for receiving a digital broadcast signal from each broadcasting station. The decoder 5 is designed for decoding the digital signals read out by the DVD playback module 2 and the hard disk record/playback module 3 and the digital signal of video and audio data intercepted by the tuner 4. The memory 6 is designed for storing broadcast channels which can be intercepted by the tuner 4 and the action programs for the controller 10. The video output 7 is designed for converting the video signal decoded by the decoder 5 into another form which can be played back on the monitor 12. The audio output 8 is designed for converting the audio signal decoded by the decoder 5 into another form which can be reproduced with the monitor 12. The remote control receiver 9 is designed for receiving a command signal over infrared ray transmission from the remote commander II and transferring the same to the controller 10. The controller 10 is designed for controlling the action of each component in the apparatus with the use of a corresponding action program stored in the memory 6. The remote commander 11 is designed responsive to a command entered by the user for transmitting an infrared ray signal of the command.

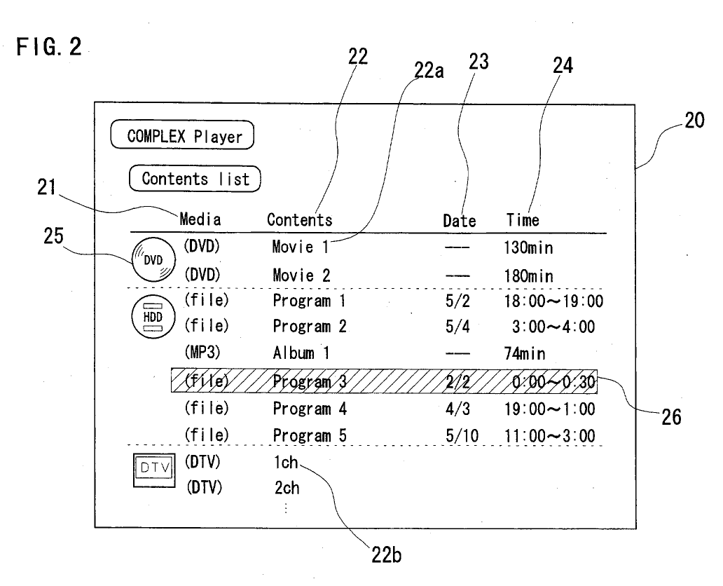

FIG. 2 illustrates a list of the contents displayed on the monitor 12 when the apparatus 1 is energized. A contents list picture 20 is displayed automatically upon switching on the power of the apparatus 1 and used as the interface by the user selecting a desired content with ease. The contents list picture 20 shows at once a list of digital contents 22a stored on an optical disk and a hard disk for playback as well as a list of broadcast channels 22b which can be intercepted by the tuner 4, where the data of each content is identified with the name (or type) of the recording medium 21, the title of the content 22, the date of recording 23, the length or time of recording 24, and so on and can be selected with much ease. The content list picture 20 also shows icons 25 at the left end for visually indicating the types of the recording mediums. The contents to be played back by the digital contents playback apparatus 1 can selectively be determined with a cursor 26. In action, the remote commander 11 allows the user to select and enter desired one of the contents using the cursor 26. For example, the “Program 3” is selected by the user as shown in FIG. 2. The user then depresses an “enter” key on the remote commander 11 for viewing the content. The selection of the contents may be carried out by a mouse, connected externally to the apparatus 1 (but not shown), moving its pointer on the contents list picture 20. The contents list picture 20 may arbitrarily be modified in the layout of the contents and the broadcast channels by the user; for example, the items are aligned from the name of the content 22 to the length or time of recording 24, the date of recording 23, and the recording medium 21.

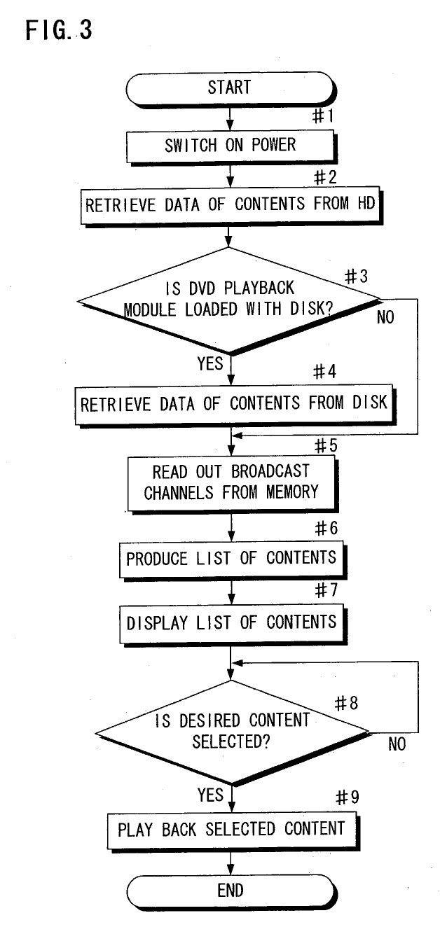

The procedure of playback action with the controller 10 from the start up of the digital contents playback apparatus 1 will be explained referring to FIG. 3. Upon being switched on the power by the user (#1), the digital contents playback apparatus 1 retrieves reproducible data of the contents from a hard disk (HD) (#2). It is then examined whether or not the DVD playback module 2 is loaded with any optical disk such as DVD or CD-ROM (#3). When any optical disk is loaded in the DVD playback module 2 (yes at #3), it is scanned for retrieving reproducible data of the contents (#4). Then, the broadcast channels which can be intercepted by the tuner 4 are read out from the memory 6 (#5). Results of the retrieving action at the steps #2 and #4 as well as the reading action at the step #5 are indexed to develop a contents list picture 20 (#6). The contents and the broadcast channels which have been retrieved can be listed in any order desired by the user on the contents list picture 20. The contents list picture 20 produced at the step #6 is then displayed on the monitor 12 (#7). This is followed by the user selecting desired one of the contents (#8) and playing back the same (#9) before closing the procedure. When no disk is loaded (no at #3), the procedure jumps to the step #5.

As described, the digital contents playback apparatus 1 of this embodiment allows the controller 10 upon being energized by the user to automatically carry out the steps from #2 to #7 shown in FIG. 3 for producing and displaying the contents list picture 20. Accordingly, the user can readily access and view the contents list picture 20 for selection from the available contents to be played back with no need of manually entering any command which is commonly required in conventional apparatus. Also, the contents list picture 20 carries a list of the available contents and the broadcast channels which is viewed at once, hence permitting the user to easily select any desired data from the available contents and the broadcast channels with no need of identifying the recording medium or entering a corresponding command for selecting the action mode. Moreover, the items on the contents list picture 20 including the available contents and the broadcast channels are enabled to be realigned to a desired layout for ease of the viewing. In other words, the digital contents playback apparatus 1 can favorably be customized by each user and hence improved in the operability.

It would be understood that the present invention is not limited to the described embodiment and any modifications and changes are possible without departing from the scope of the present invention. For example, the digital contents playback module in the apparatus is not limited to the DVD playback module 2 but may be a CD-ROM playback module, an optomagnetic disk playback module, or their combination. Also, the digital contents record/playback module is not limited to the hard disk record/playback module 3 but may be any other device capable of recording and playing back a large amount of digital data at high speeds. Alternatively, the digital contents playback apparatus 1 may be equipped without the tuner 4. In this case, the apparatus 1 is connected at its AUX (auxiliary) ports by cables to an external broadcast receiver such as an STB (set top box) for receiving video and audio broadcast signals.

What is claimed is:

1. A digital contents playback apparatus having two or more playback means for playing back different types of recording mediums on which digital contents of data are stored, comprising:
an automatic contents retrieving means for automatically retrieving reproducible data of the digital contents from each recording medium upon switching on a power of the digital contents playback apparatus; and
a contents data displaying means for producing a list of the contents from the data retrieved by the automatic contents retrieving means and displaying the list on an externally connected display device, wherein
the contents data displaying means is arranged to display at once a list of the available digital contents retrieved over all the applicable recording mediums by the automatic contents retrieving means upon switching on the power of the apparatus.

2. A digital contents playback apparatus according to claim 1, further comprising:
an entry means for allowing a user to enter a variety of commands; and
a content selecting means for selecting, in response to a command from the entry means, a desired content from the list of the contents produced and displayed on the display device by the contents data displaying means.

3. A digital contents playback apparatus according to claim 1, wherein
the playback means are an optical disk playback means for playing back the digital contents stored on an optical disk and a hard disk record/playback means for recording desired contents of data on a hard disk and playing back any selected one of the contents, and
the automatic contents retrieving means includes an automatic optical disk retrieving means for automatically retrieving from the optical disk reproducible data of the contents to be played back by the optical disk playback means upon switching on a power of the apparatus and an automatic hard disk retrieving means for automatically retrieving from the hard disk reproducible data of the contents to be played back by the hard disk record/playback means upon switching on the power of the apparatus.

4. A digital contents playback apparatus according to claim 1, further comprising:
a signal receiving means for receiving digital broadcast signals from each local station; and
a channel storage means in which data of broadcast channels which can be received by the signal receiving means are stored, wherein
the contents data displaying means is arranged to produce a list of the digital contents from the available data retrieved over all the applicable recording mediums by the automatic contents retrieving means and the data of the broadcast channels stored in the channel storage means.

5. A digital contents playback apparatus according to claim 1, wherein
the contents data displaying means is arranged to modify the layout of the contents of digital data and broadcast channels in the list to a desired form determined by a user and display a modification of the list of the digital contents and the broadcast channels.
